(19) United States
(12) Patent Application Publication
(10) Pub. No.: US 2023/0342662 A1
(43) Pub. Date: Oct. 26, 2023

(54) METHOD, ELECTRONIC DEVICE, AND COMPUTER PROGRAM PRODUCT FOR MODEL TRAINING

(71) Applicant: Dell Products L.P., Round Rock, TX (US)

(72) Inventors: Jiacheng Ni, Shanghai (CN); Zijia Wang, WeiFang (CN); Zhen Jia, Shanghai (CN)

(21) Appl. No.: 17/828,157

(22) Filed: May 31, 2022

(30) Foreign Application Priority Data
Apr. 22, 2022 (CN) 202210431123.5

(51) Int. Cl. G06N 20/00; G06K 9/62; H04L 67/10

(52) U.S. Cl. CPC G06N 20/00; G06K 9/6277; G06K 9/628; H04L 67/10

(57) ABSTRACT

Embodiments of the present disclosure provide a method, an electronic device, and a computer program product for model training. The method for model training includes: receiving, at an edge device, a machine learning model and distilled samples from a cloud server, wherein the machine learning model is trained on the basis of initial samples at the cloud server, and the distilled samples are obtained by distillation of the initial samples. The method further includes: acquiring, at the edge device, a newly collected input sample, and retraining, by the edge device, the machine learning model by using the distilled samples and the input sample. In this way, by updating a model using a distilled sample set at an edge device, the efficiency of updating the model can be improved, and then the accuracy of the model can be improved.

### RELATED APPLICATION(S)

The present application claims priority to Chinese Patent Application No. 202210431123.5, filed Apr. 22, 2022, and entitled “Method, Electronic Device, and Computer Program Product for Model Training,” which is incorporated by reference herein in its entirety.

### FIELD

Embodiments of the present disclosure relate to the field of computers, and more specifically, to a method, an electronic device, and a computer program product for model training.

### BACKGROUND

Edge computing architecture usually includes a cloud server, an edge server, and a terminal device. In order to enable the edge server to quickly respond to service requirements of the terminal device, some machine learning models for specific services are sent from the cloud server to the edge server. In this way, the terminal device can use a corresponding machine learning model for deduction.

During the operation, the terminal device will continuously acquire new sample examples. At this moment, the model needs to be updated, which is, for example, a common problem during the application of a deep neural network (DNN).

### SUMMARY

Embodiments of the present disclosure provide a solution for quickly updating a machine learning model at an edge device.

In a first aspect of the present disclosure, a method for model training is provided. The method includes receiving, at an edge device, a machine learning model and distilled samples from a cloud server. The machine learning model is trained on the basis of initial samples at the cloud server, and the distilled samples are obtained by distillation of the initial samples. The method further includes acquiring, at the edge device, a newly collected input sample. Finally, the solution further includes: retraining, by the edge device, the machine learning model by using the distilled samples and the input sample.

In a second aspect of the present disclosure, an electronic device is provided. The electronic device includes: a processor; and a memory coupled to the processor. The memory has instructions stored therein, and the instructions, when executed by the processor, cause the device to execute actions. The actions include receiving, at an edge device, a machine learning model and distilled samples from a cloud server. The machine learning model is trained on the basis of initial samples at the cloud server, and the distilled samples are obtained by distillation of the initial samples. The actions further include acquiring, at the edge device, a newly collected input sample.

Finally, the actions further include retraining, by the edge device, the machine learning model by using the distilled samples and the input sample.

In a third aspect of the present disclosure, a computer program product is provided. The computer program product is tangibly stored on a non-transitory computer-readable medium and includes machine-executable instructions. The machine-executable instructions, when executed by a machine, cause the machine to perform the method according to the first aspect.

This Summary is provided to introduce the selection of concepts in a simplified form, which will be further described in the Detailed Description below. The Summary is neither intended to identify key features or main features of the present disclosure, nor intended to limit the scope of the present disclosure.

### BRIEF DESCRIPTION OF THE DRAWINGS

By more detailed description of example embodiments of the present disclosure, provided herein with reference to the accompanying drawings, the above and other objectives, features, and advantages of the present disclosure will become more apparent, where identical reference numerals generally represent identical components in the example embodiments of the present disclosure. In the accompanying drawings:

FIG. 1 shows a schematic diagram of a cloud/edge system in which an embodiment of the present disclosure can be implemented;

FIG. 2 shows a flow chart of an example method for model training according to an embodiment of the present disclosure;

FIG. 3 shows a flow chart of an example method for model training according to an embodiment of the present disclosure;

FIG. 4 shows a schematic diagram of an example process of model update according to an embodiment of the present disclosure; and

FIG. 5 illustrates a block diagram of an example device that can be used to implement embodiments of the present disclosure.

### DETAILED DESCRIPTION

Principles of the present disclosure will be described below with reference to several example embodiments illustrated in the accompanying drawings. Although the drawings show example embodiments of the present disclosure, it should be understood that these embodiments are merely described to enable those skilled in the art to better understand and further implement the present disclosure, and not to limit the scope of the present disclosure in any way.

The term “include” and variants thereof used herein indicate open-ended inclusion, that is, “including but not limited to.” Unless specifically stated, the term “or” means “and/or.” The term “based on” means “based at least in part on.” The terms “an example embodiment” and “an embodiment” indicate “at least one example embodiment.” The term “another embodiment” indicates “at least one additional embodiment.” The terms “first,” “second,” and the like may refer to different or identical objects. Other explicit and implicit definitions may also be included below.

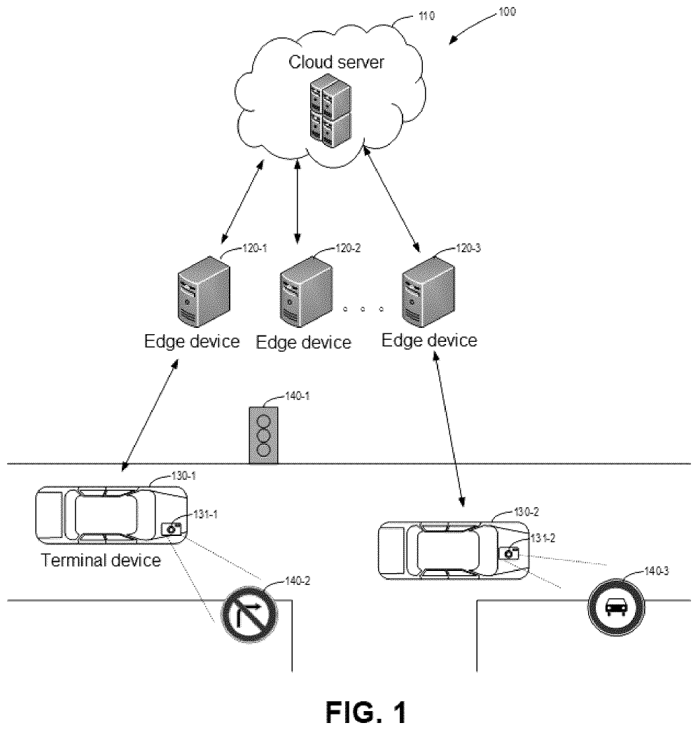

FIG. 1 shows a schematic diagram of cloud/edge system 100 in which an embodiment of the present disclosure can be implemented. As shown in FIG. 1, cloud/edge system 100 can include a cloud layer, an edge layer, and a terminal device layer. The cloud layer may include cloud server 110. Cloud server 110 can include one or more cloud computing devices, and these computing devices usually have abundant computing resources and storage resources and can perform complex computing tasks. As a processing center, for example, the cloud server is a computing center of cloud/edge architecture, and a computing result of an edge device or other data can be permanently stored by the cloud server. An analysis task with high importance is usually completed by the operation of the cloud server. At the same time, the cloud server may further perform policy distribution and management on the edge device. The edge layer may include one or more edge devices 120-1, 120-2, 120-3 (collectively or individually referred to as edge device 120), and these edge devices 120 usually only have limited computing resources and storage resources and cannot perform complex computing tasks. The terminal device layer may include one or more terminal devices 130, such as mobile terminals, cameras, and vehicles with cameras, and these terminal devices 130 may collect sample data and perform simple computing tasks. In the embodiment shown in FIG. 1, terminal device 130-1 and terminal device 130-2 (collectively or individually referred to as terminal device 130) are both vehicles traveling on a road. For example, terminal device 130-1 and terminal device 130-2 are respectively configured with image capture devices 131-1 and 131-2 configured to collect an image of an environment where they are located. Terminal device 130 is composed of various Internet of things (IoT) data collection devices and mainly carries out data collection, and its data computing capability is not considered. For example, terminal device 130 can direct data to the edge device or the cloud server as a carrier in the form of input.

In the embodiment shown in FIG. 1, terminal device 130 is, for example, an autonomous vehicle or an assisted driving vehicle. In order to enable terminal device 130 to make an action that is in line with one or more of signs, illustratively including traffic light sign 140-1, no-right-turn sign 140-2 and car passing sign 140-3 (collectively or individually referred to as sign 140) when detecting sign 140, terminal device 130 uses a computing resource at edge device 120 for deduction, so as to identify sign 140. In order to provide a computing service, a classification model used for classifying a sign to identify a detected sign, for example, is deployed at edge device 120. The classification model may be obtained by training at cloud server 110 on the basis of a full sample set with an extremely large number of samples.

As shown in FIG. 1, there are terminal devices 130-1 and 130-2 traveling on a road. Terminal device 130-2 is located in front of terminal device 130-1 in the road and detects car passing sign 140-3. At the same time, terminal device 130-1 travels to a T-shaped intersection, and detects traffic light sign 140-1 on the left side of the road and no-right-turn sign 140-2 on the right side of the road. Traffic light sign 140-1 may currently be a red light, for example, indicating a need to temporarily bring terminal device 130-1 to a stop. However, the class to which no-right-turn sign 140-2 belongs is not included in an initial sample set, so that terminal device 130-1 cannot determine the class of this sign by using a classification model at edge device 120-1 that is in communicative connection with the terminal device.

At this moment, since terminal device 130-1 determines that no-right-turn sign 140-2 cannot be identified, and does not know how to travel, terminal device 130-1 may, for example, seek help from manual intervention, thus determining that no-right-turn sign 140-2 indicates no right turn. Thus, terminal device 130-1 obtains an identifier of no-right-turn sign 140-2, takes the same as a label, and sends it to edge device 120-1. When edge device 120-1 receives a sample of a new type, it is necessary to update the trained classification model so that it can correctly classify the sample of the new type.

Conventionally, for example, the trained classification model may be fine-tuned with the received sample of the new type at edge device 120, or edge device 120 may send the sample of the new type to cloud server 110, and at cloud server 110, an initial sample set of the sample of the new type is used for extension, and then the classification model is retrained using extended full samples.

However, using a full sample set to retrain classification is quite time-consuming and cannot satisfy specific time-sensitive application scenarios. By only using a sample of a new type to finely tune a classification model, on the other hand, it is difficult to adjust the learning rate to balance the influence on a new sample set and an initial sample set. Therefore, there is a need to update a model more quickly to improve the efficiency of model training.

An embodiment of the present disclosure provides a solution for updating a model at an edge device by using a distilled sample set, so as to solve one or more of the above problems and other potential problems. In this solution, at a cloud server, a full sample set is used to train a machine learning model, and the sample set is distilled; the trained machine learning model and distilled samples are sent to an edge device; and after the edge device receives new samples, the machine learning model is updated at the edge device. In this way, the speed of model update of an edge/cloud system can be increased, so as to adapt to time-sensitive application scenarios.

It should be understood that the classification model described herein is only an example machine learning model and not intended to limit the scope of the present disclosure. Any specific machine learning model can be selected according to a specific application scenario.

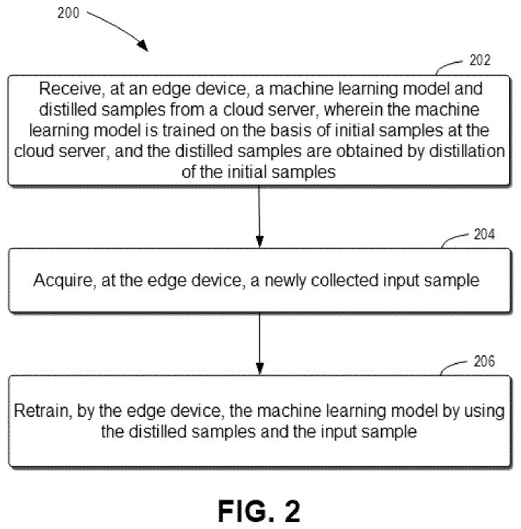

Example embodiments of the present disclosure will be described in detail below with reference to FIG. 2 to FIG. 4.

FIG. 2 illustrates a flow chart of example method 200 for model training according to an embodiment of the present disclosure. Method 200 can be implemented, for example, at edge device 120 as shown in FIG. 1. It should be understood that method 200 may also include additional actions not shown and/or may omit actions shown, and the scope of the present disclosure is not limited in this regard. Method 200 will be described in detail below with reference to FIG. 1 and FIG. 2.

At 202, edge device 120 receives a machine learning model and distilled samples from cloud server 110. Here, the machine learning model is trained on the basis of initial samples (e.g., a full sample set) at the cloud server, and the distilled samples are obtained by distillation of the initial samples. That is, both the machine learning model and the distilled samples are obtained on the basis of the initial samples. In some embodiments, the distilled samples may be obtained on the basis of a data distillation algorithm. Data distillation is an algorithm that refines knowledge from a large training dataset into small data. In some embodiments, a small number of samples may be a small number of synthesized samples, or typical samples selected from a full sample set and containing characterization data features. Although the number of distilled samples is far fewer than the number of initial samples, when used as training data of a model for training the model, the distilled samples can achieve an effect similar to that of training on the initial sample set.

At 204, edge device 120 acquires a newly collected input sample, e.g., an input sample acquired from terminal device 130. In some embodiments, the machine learning model may be a classification model for classifying objects, and edge device 120 may process the input sample by using the classification model to determine a classification result. The determined classification result may indicate a corresponding probability of the input sample for each of a plurality of classes. For example, the classification result may be a result of a Softmax function. The classification result obtained here can be used in subsequent calculations.

At 206, edge device 120 retrains the machine learning model by using the distilled samples and the input sample. In some embodiments, edge device 120 may periodically retrain the machine learning model by using the distilled samples and the input sample. In some other embodiments, edge device 120 may retrain the machine learning model by using the distilled samples and the input sample when a predetermined number of new samples are received. Thus, for example, retraining is performed only when edge device 120 receives new samples of which the number corresponds to the number of the distilled samples, so that the problem that samples for the classes are unbalanced can be avoided.

Therefore, by updating the model with a small distilled sample set at the edge device, the time for transmitting new samples to the cloud server can be saved. Furthermore, since the number of samples used is far fewer than the number of initial samples, the efficiency of model update is further improved, thereby improving the accuracy of the model. In this way, for example, when terminal device 130-1 shown in FIG. 1 encounters no-right-turn sign 140-2 again during the same traveling process, the terminal device can preparatively classify this sign.

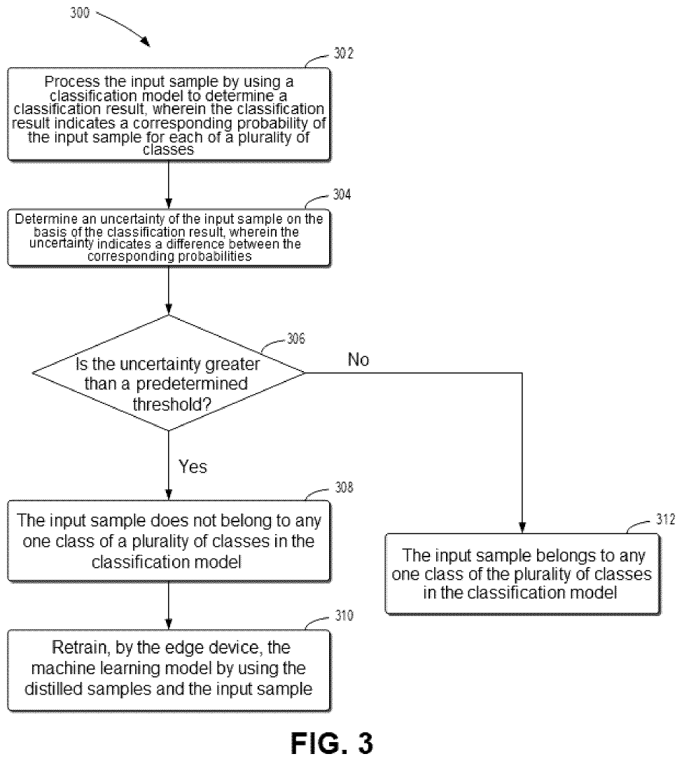

In some embodiments, edge device 120 may update the model by using the new sample when it is determined that the received new sample does not belong to the classes of the classification model, that is, when the classification model cannot provide a trusted result. A method of model update according to such embodiment will be described in detail below with reference to FIG. 3.

FIG. 3 shows a flow chart of example method 300 of model training according to an embodiment of the present disclosure. Method 300 can be implemented, for example, at edge device 120 as shown in FIG. 1. It should be understood that method 300 may also include additional actions not shown and/or may omit actions shown, and the scope of the present disclosure is not limited in this regard. Method 300 will be described in detail below with reference to FIG. 3 and FIG. 1.

As shown in FIG. 3, at 302, edge device 120 may process an input sample by using a classification model to determine a classification result. The classification result here indicates a corresponding probability of the input sample for each of a plurality of classes, and the uncertainty of the input sample is determined on the basis of the classification result.

At 304, edge device 120 determines the uncertainty of the input sample on the basis of the classification result. The uncertainty here indicates a difference between the corresponding probabilities. For example, when the probability of the input sample for each class is similar, that is, when the difference between the corresponding probabilities is small, the model cannot determine the class of the input sample on this basis, and the uncertainty of the input sample is high at this moment. On the contrary, when one of the probabilities of the input sample for the classes is significantly different from other probabilities, the model can determine the class corresponding to the probability that is significantly different from the other probabilities as the class of the input sample. In some embodiments, the uncertainty may be an information entropy. In this embodiment, the uncertainty represents the amount of information to be additionally acquired to determine the class of the input sample. For example, when the difference between the probabilities is large, the class is easy to determine, so that the amount of information to be acquired is small.

At 306, edge device 120 determines whether the determined uncertainty is greater than a predetermined threshold. If the uncertainty is not greater than the predetermined threshold, method 300 proceeds to 312. At 312, edge device 120 determines that the input sample belongs to any one class of the plurality of classes in the classification model. Thus, it is determined that the classification model can accurately classify input samples of this type, so that it is not necessary to update the classification model.

On the contrary, if the uncertainty is greater than the predetermined threshold, method 300 proceeds to 308.

At 308, edge device 120 determines that the input sample does not belong to any one class of the plurality of classes in the classification model. Therefore, after the uncertainty of the input sample is determined, when edge device 120 determines that the uncertainty of the input sample is greater than a predetermined threshold, it can be determined that the input sample does not belong to any one class of the plurality of classes in the classification model. That is, if the uncertainty of the received input sample is extremely high, the class of the input sample cannot be confirmed, that is, it is most likely that the input sample belongs to a new class. For example, since no-right-turn sign 140-2 in FIG. 1 does not belong to any class in the classification model, it cannot be classified by the classification model. Then, at 310, edge device 120 retrains the machine learning model by using the distilled samples and the input sample. When edge device 120 determines that the input sample does not belong to any one class of the plurality of classes in the classification model, in order to enable the classification model to identify the sample of the new type as soon as possible, the edge device retrains the machine learning model by using the distilled samples and the input sample. In this way, the model is updated only when it is determined that the new sample belongs to a new class, so that utilization of useless samples for model training can be avoided, thus saving computing resources.

In some embodiments, edge device 120 may train the model by using supervised learning. For this purpose, edge device 120 may acquire a new class for the input sample. For example, a correct class of the input sample is acquired by manual intervention. Later, on the basis of the acquired class, edge device 120 determines, in the input sample, a sample subset associated with the new class, and then retrains the machine learning model by using the distilled samples and the sample subset. In this way, by using supervised learning to retrain the model after the correct class is obtained, the model can be updated more efficiently.

In some embodiments, edge device 120 can send the input sample from the edge device to the cloud server, so that the cloud server trains the machine learning model by using the input sample and the initial samples. In this way, if time permits, the model is updated at the cloud server by using an extended full sample set, so that a more accurate model can be obtained.

In some embodiments, edge device 120 can receive an updated machine learning model from the cloud server. The updated machine learning model here is trained on the basis of the initial samples and input samples received from a plurality of edge devices. In this way, the cloud server trains a model by using a plurality of samples acquired from a plurality of edge devices, so that a more comprehensive model can be obtained.

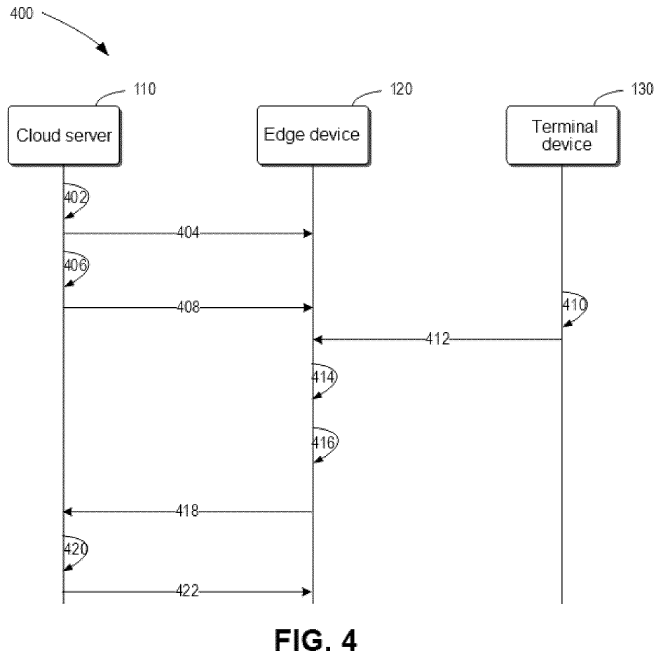

FIG. 4 shows a schematic diagram of example process 400 of model update according to an embodiment of the present disclosure. Process 400 may be regarded as a specific implementation of method 200. It should be understood that process 400 may also include additional actions not shown and/or may omit actions shown, and the scope of the present disclosure is not limited in this regard. Process 400 is described in detail below with reference to FIG. 1 and FIG. 4.

As shown in FIG. 4, process 400 involves cloud server 110, edge device 120, and terminal device 130 in FIG. 1. At 402, cloud server 110 trains a classification model by using an initial sample set. Cloud server 110, for example, trains a classification model used for classifying signs by using a sample set including various signs.

At 404, cloud server 110 sends the trained classification model to edge device 120.

At 406, cloud server 110 distills the initial sample set by using a data distillation algorithm to obtain distilled samples. The number of the distilled samples is far fewer than the number of initial samples, but their training effects are similar.

At 408, cloud server 110 sends the extracted distilled samples to edge device 120. At this point, initial deployment has been completed, and terminal device 130 can classify detected signs by using edge device 120.

At 410, terminal device 130 detects a new sample (also referred to as an input sample). Then, at 412, terminal device 130 sends the new sample to edge device 120.

At 414, edge device 120 determines, by calculating an information entropy of the new sample, whether the new sample can be classified.

At 416, when it is determined that the new sample cannot be classified, that is, when data drift occurs, edge device 120 retrains the classification model by using the distilled samples and the new sample. Thus, model update at the edge device is completed.

At 418, edge device 120 further sends the new sample to cloud server 110.

At 420, cloud server 110 retrains the classification model by using the new sample and the initial samples.

At 422, cloud server 110 sends the updated classification model to edge device 120. Thus, edge device 120 obtains a more comprehensive classification model.

In this way, efficient and fast model update is achieved through the cooperation between the three layers of devices, so that the edge/cloud system can be applicable to time-sensitive services.

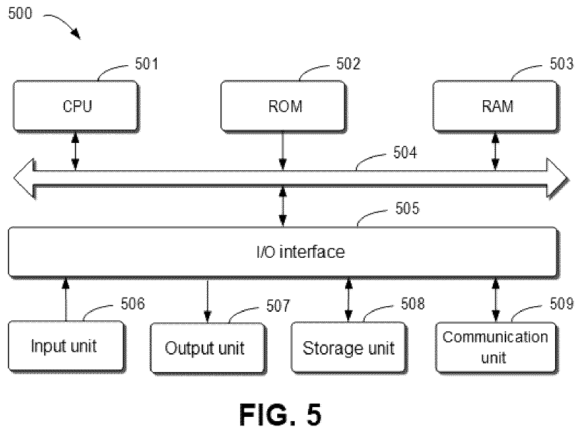

FIG. 5 shows a schematic block diagram of example device 500 that may be used to implement embodiments of the present disclosure. As shown in FIG. 5, device 500 includes central processing unit (CPU) 501 which may perform various appropriate actions and processing according to computer program instructions stored in read-only memory (ROM) 502 or computer program instructions loaded from storage unit 508 to random access memory (RAM) 503. Various programs and data required for operations of device 500 may also be stored in RAM 503. CPU 501, ROM 502, and RAM 503 are connected to each other through bus 504. Input/output (I/O) interface 505 is also connected to bus 504.

A plurality of components in device 500 are connected to I/O interface 505, including: input unit 506, such as a keyboard and a mouse; output unit 507, such as various classes of displays and speakers; storage unit 508, such as a magnetic disk and an optical disc; and communication unit 509, such as a network card, a modem, and a wireless communication transceiver. Communication unit 509 allows device 500 to exchange information/data with other devices via a computer network, such as the Internet, and/or various telecommunication networks.

The various processes and processing described above, such as method 200 and method 300, may be performed by CPU 501. For example, in some embodiments, methods 200 and 300 may be implemented as a computer software program that is tangibly included in a machine-readable medium, such as storage unit 508. In some embodiments, part of or all the computer program may be loaded and/or installed to device 500 via ROM 502 and/or communication unit 509. When the computer program is loaded to RAM 503 and executed by CPU 501, one or more actions in methods 200 and 300 described above can be executed.

Examples embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented by using a special hardware-based system that executes specified functions or actions, or implemented by using a combination of special hardware and computer instructions.

Example embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms used herein is intended to best explain the principles and practical applications of the various embodiments or the improvements to technologies on the market, so as to enable persons of ordinary skill in the art to understand the embodiments disclosed herein.

What is claimed is:

1. A method for model training, comprising:
receiving, at an edge device, a machine learning model and distilled samples from a cloud server, wherein the machine learning model is trained on the basis of initial samples at the cloud server, and the distilled samples are obtained by distillation of the initial samples;
acquiring, at the edge device, a newly collected input sample; and
retraining, by the edge device, the machine learning model by using the distilled samples and the input sample.

2. The method according to claim 1, wherein the machine learning model is a classification model used for classifying objects, and acquiring, at the edge device, a newly collected input sample comprises:
processing the input sample by using the classification model to determine a classification result, wherein the classification result indicates a corresponding probability of the input sample for each of a plurality of classes.

3. The method according to claim 2, wherein retraining, by the edge device, the machine learning model by using the distilled samples and the input sample comprises:
determining an uncertainty of the input sample on the basis of the classification result, wherein the uncertainty indicates a difference between the corresponding probabilities;
in response to the uncertainty being greater than a predetermined threshold, determining that the input sample does not belong to any one class of the plurality of classes in the classification model; and
in response to determining that the input sample does not belong to any one class of the plurality of classes in the classification model, retraining, by the edge device, the machine learning model by using the distilled samples and the input sample.

4. The method according to claim 2, wherein retraining, by the edge device, the machine learning model by using the distilled samples and the input sample comprises:
acquiring a new class for the input sample;
determining, in the input sample, a sample subset associated with the new class; and
retraining, by the edge device, the machine learning model by using the distilled samples and the sample subset.

5. The method according to claim 1, further comprising:
sending the input sample from the edge device to the cloud server, so that the cloud server trains the machine learning model by using the input sample and the initial samples.

6. The method according to claim 5, further comprising:
receiving, at the edge device, an updated machine learning model from the cloud server, wherein the updated machine learning model is trained on the basis of the initial samples and input samples received from a plurality of edge devices, and the plurality of edge devices comprise the edge device.

7. The method according to claim 1, wherein the number of the distilled samples is less than the number of the initial samples, and the distilled samples indicate a same sample distribution as that of the initial samples.

8. An electronic device, comprising:
a processor; and
a memory coupled to the processor, wherein the memory has instructions stored therein, and the instructions, when executed by the processor, cause the device to execute actions comprising:
receiving, at an edge device, a machine learning model and distilled samples from a cloud server, wherein the machine learning model is trained on the basis of initial samples at the cloud server, and the distilled samples are obtained by distillation of the initial samples;
acquiring, at the edge device, a newly collected input sample; and
retraining, by the edge device, the machine learning model by using the distilled samples and the input sample.

9. The electronic device according to claim 8, wherein the machine learning model is a classification model used for classifying objects, and acquiring, at the edge device, a newly collected input sample comprises:
processing the input sample by using the classification model to determine a classification result, wherein the classification result indicates a corresponding probability of the input sample for each of a plurality of classes.

10. The electronic device according to claim 9, wherein retraining, by the edge device, the machine learning model by using the distilled samples and the input sample comprises:
determining an uncertainty of the input sample on the basis of the classification result, wherein the uncertainty indicates a difference between the corresponding probabilities;
in response to the uncertainty being greater than a predetermined threshold, determining that the input sample does not belong to any one class of the plurality of classes in the classification model; and
in response to determining that the input sample does not belong to any one class of the plurality of classes in the classification model, retraining, by the edge device, the machine learning model by using the distilled samples and the input sample.

11. The electronic device according to claim 9, wherein retraining, by the edge device, the machine learning model by using the distilled samples and the input sample comprises:
acquiring a new class for the input sample;
determining, in the input sample, a sample subset associated with the new class; and
retraining, by the edge device, the machine learning model by using the distilled samples and the sample subset.

12. The electronic device according to claim 8, wherein the actions further comprise:
sending the input sample from the edge device to the cloud server, so that the cloud server trains the machine learning model by using the input sample and the initial samples.

13. The electronic device according to claim 12, wherein the actions further comprise:
receiving, at the edge device, an updated machine learning model from the cloud server, wherein the updated machine learning model is trained on the basis of the initial samples and input samples received from a plurality of edge devices, and the plurality of edge devices comprise the edge device.

14. The electronic device according to claim 8, wherein the number of the distilled samples is less than the number of the initial samples, and the distilled samples indicate a same sample distribution as that of the initial samples.

15. A computer program product tangibly stored on a non-transitory computer-readable medium and comprising machine-executable instructions, wherein the machine-executable instructions, when executed by a machine, cause the machine to perform a method for model training, the method comprising:
receiving, at an edge device, a machine learning model and distilled samples from a cloud server, wherein the machine learning model is trained on the basis of initial samples at the cloud server, and the distilled samples are obtained by distillation of the initial samples;
acquiring, at the edge device, a newly collected input sample; and
retraining, by the edge device, the machine learning model by using the distilled samples and the input sample.

16. The computer program product according to claim 15, wherein the machine learning model is a classification model used for classifying objects, and acquiring, at the edge device, a newly collected input sample comprises:
processing the input sample by using the classification model to determine a classification result, wherein the classification result indicates a corresponding probability of the input sample for each of a plurality of classes.

17. The computer program product according to claim 16, wherein retraining, by the edge device, the machine learning model by using the distilled samples and the input sample comprises:
determining an uncertainty of the input sample on the basis of the classification result, wherein the uncertainty indicates a difference between the corresponding probabilities;
in response to the uncertainty being greater than a predetermined threshold, determining that the input sample does not belong to any one class of the plurality of classes in the classification model; and
in response to determining that the input sample does not belong to any one class of the plurality of classes in the classification model, retraining, by the edge device, the machine learning model by using the distilled samples and the input sample.

18. The computer program product according to claim 16, wherein retraining, by the edge device, the machine learning model by using the distilled samples and the input sample comprises:
acquiring a new class for the input sample;
determining, in the input sample, a sample subset associated with the new class; and
retraining, by the edge device, the machine learning model by using the distilled samples and the sample subset.

19. The computer program product according to claim 15, further comprising:
sending the input sample from the edge device to the cloud server, so that the cloud server trains the machine learning model by using the input sample and the initial samples.

20. The computer program product according to claim 19, further comprising:
receiving, at the edge device, an updated machine learning model from the cloud server, wherein the updated machine learning model is trained on the basis of the initial samples and input samples received from a plurality of edge devices, and the plurality of edge devices comprise the edge device.
